(19) United States
(12) Patent Application Publication
(10) Pub. No.: US 2012/0115344 A1
(43) Pub. Date: May 10, 2012

(54) CONTACT BLOCK

(75) Inventor: Ken Makiguchi, Osaka (JP)

(73) Assignee: SHARP KABUSHIKI KAISHA, Osaka-shi, Osaka (JP)

(21) Appl. No.: 13/384,522

(22) PCT Filed: Apr. 9, 2010
(86) PCT No.: PCT/JP2010/002607

§ 371 Date: Jan. 17, 2012

(30) Foreign Application Priority Data
Aug. 26, 2009 (JP) 2009-195377

(51) Int. Cl. H01R 13/64

(52) U.S. Cl. 439/246

(57) ABSTRACT

A contact block for electrically connecting connection terminals together includes a conductive block having an elastic body and a conductive member held inside the elastic body, and an alignment case having a through-hole into which the conductive block is inserted. The through-hole is formed in a shape corresponding to arrangement of the connection terminals.

### TECHNICAL FIELD

The present invention relates to a contact block for electrically connecting connection terminals of electronic circuits together. In particular, the present invention relates to a contact block which is useful for a temporal connection with various models of devices such as testing devices and which can be also used for specially-shaped connection terminals of, e.g., a liquid crystal display, an organic electro luminescence (EL) display, and a plasma display.

### BACKGROUND ART

For example, a liquid crystal display device in which a plurality of pixels are arranged in a matrix includes a connection terminal section in which many connection terminals of electrode wires for driving each of the pixels are arranged. In an electrification test for an electronic device including such a connection terminal section, a probe unit in which a plurality of probe needles are bundled and fixed corresponding to arrangement of connection terminals of the device to be tested is incorporated into a testing device.

For the liquid crystal display devices, there are various sizes of, e.g., 1 to 50 inches and a plurality of resolutions such as an extended graphics array (XGA) resolution, a super extended graphics array (SXGA) resolution, and a wide ultra extended graphics array (WUXGA) resolution. Many models of liquid crystal devices are manufactured, and a small to moderate number of liquid crystal display devices are manufactured for each model. For the testing device of the liquid crystal display devices, various types of probe units are prepared corresponding to each model of the liquid crystal display devices. When the model of the liquid crystal display devices to be manufactured is temporarily switched, the probe unit is exchanged to the one corresponding to the switched model, and then the electrification test is performed.

Thus, a probe unit improved considering reliability and versatility has been proposed.

Patent Document 1 discloses an anisotropic conductive rubber connector for, even if printed boards are apart from each other with a large clearance, minimizing misalignment between contact surfaces of the printed boards.

Patent Document 2 discloses a probe unit which can be shared even if the size of a liquid crystal display device and the number and pitch of signal input terminals are different among liquid crystal display devices.

### CITATION LIST

### Patent Document

PATENT DOCUMENT 1: Japanese Patent Publication No. H09-232018

PATENT DOCUMENT 2: Japanese Patent Publication No. 2004-037184

### SUMMARY OF THE INVENTION

### Technical Problem

Most of conventional display panels used for, e.g., televisions are in a rectangular shape. Both of Patent Documents 1 and 2 disclose the probe unit corresponding to such a rectangular panel. FIG. 6(a) illustrates a display panel 20 formed in a rectangular shape. The display panel 20 includes a display section 9, drive circuits 8, connection terminal sections 7, etc. In addition, as illustrated in FIG. 7(a), a plurality of connection terminals 7a are linearly arranged along an outer shape of the display panel 20 in the connection terminal section 7 of the display panel 20. A plurality of probe needles are fixed so as to be positioned relative to the connection terminals 7a in an X direction (in one direction), thereby forming the probe unit corresponding to the connection terminals 7a.

In recent years, panels (hereinafter referred to as “irregularly-shaped panels”) having bent portions or curved portions, such as a display section of a wristwatch and an installment panel of an automobile, have been used. For example, there are irregularly-shaped panels illustrated in FIGS. 6(b) and 6(c). Since the foregoing irregularly-shaped panels continue to progress in frame width reduction due to the emphasis on a design, the drive circuits 8 and the connection terminal sections 7 are arranged around the display section 9 without clearances. As illustrated in FIGS. 7(b) and 7(c), since the connection terminals 7a are arranged in a V-shape or a U-shape in the irregularly-shaped panel, accurate positioning of the probe needles relative to the connection terminals 7a in the X and Y directions (in two directions) is required in the associated probe unit. However, the positioning in two directions is difficult in each of the probe units described in Patent Documents 1 and 2, and manufacturing of the probe unit becomes complicated. As a result, the cost of the probe unit is increased.

In preparation for the switching of the device model, the plural types of probe units corresponding to respective device models are required for the testing device in advance. However, it is difficult to prepare the plural types of expensive probe units for the irregularly-shaped panels. In addition, when a panel shape is changed in association with, e.g., the switching of the device model, such a change cannot be handled at once.

### Solution to the Problem

The present invention is directed to a contact block for electrically connecting connection terminals together, which includes a conductive block including an elastic body and a conductive member held inside the elastic body; and an alignment case including a through-hole into which the conductive block is inserted. The through-hole is formed in a shape corresponding to arrangement of the connection terminals.

### Advantages of the Invention

According to the present invention, a combination of the alignment case and the conductive block allows that a versatile contact block which is adaptable to various terminal arrangement shapes and terminal pitches is provided at low cost.

Maintenance and management can be performed separately for each of the alignment case and the conductive block. Thus, upon a sudden change in panel shape or unexpected repair and replacement, such a situation can be handled by recombining the alignment case and the conductive block.

### BRIEF DESCRIPTION OF THE DRAWINGS

FIGS. 1(a) to 1(c) are plan views of various types of alignment cases.

FIGS. 2(a) and 2(b) are a perspective view and a plan view of a conductive block, respectively.

FIG. 3 is a perspective view of a contact block of an embodiment of the present invention.

FIGS. 4(a) and 4(b) are plan views illustrating variations of the alignment case.

FIG. 5 is a view illustrating a case where an electrification test is performed by using the contact block of the present invention.

FIGS. 6(a) to 6(c) are plan views of various types of display panels.

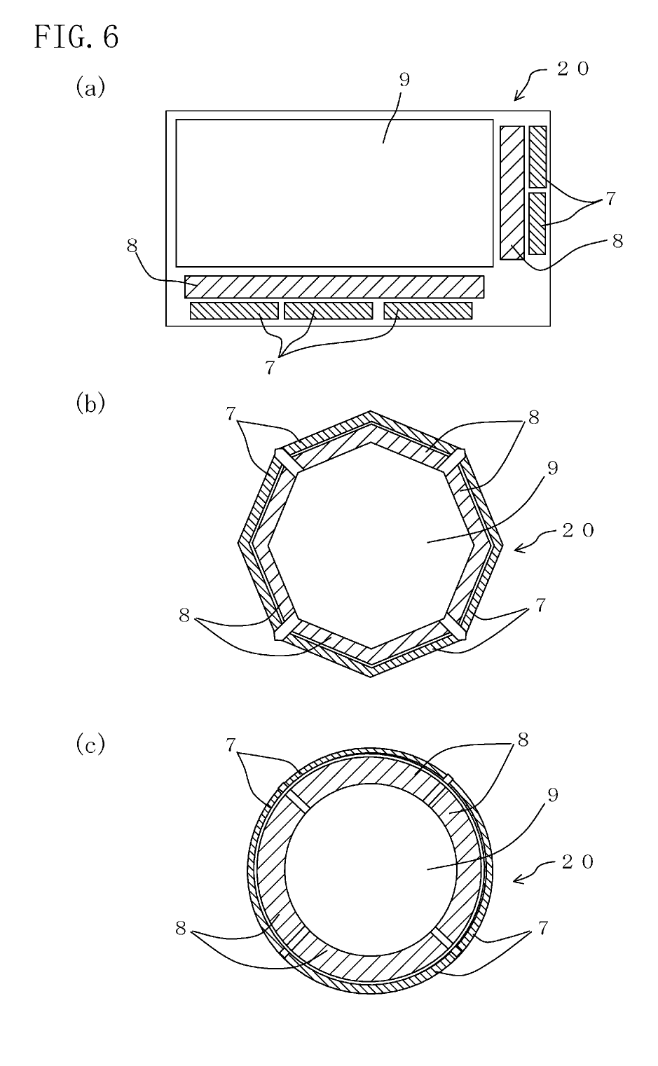

FIGS. 7(a) to 7(c) are plan views each illustrating an arrangement layout of connection terminals in a connection terminal section.

### DESCRIPTION OF EMBODIMENTS

Embodiments of the present invention will be described below with reference to attached drawings.

### First Embodiment

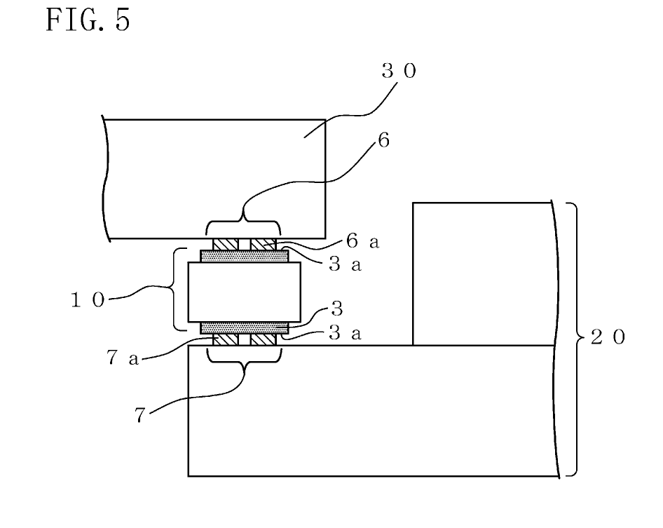

FIG. 5 illustrates a state in which a contact block 10 of the present invention is used to electrically connect a connection terminal section 7 (connection terminals 7a) of a display panel 20 such as a rectangular panel or an irregularly-shaped panel with a connection terminal section 6 (connection terminals 6a) of a testing board 30.

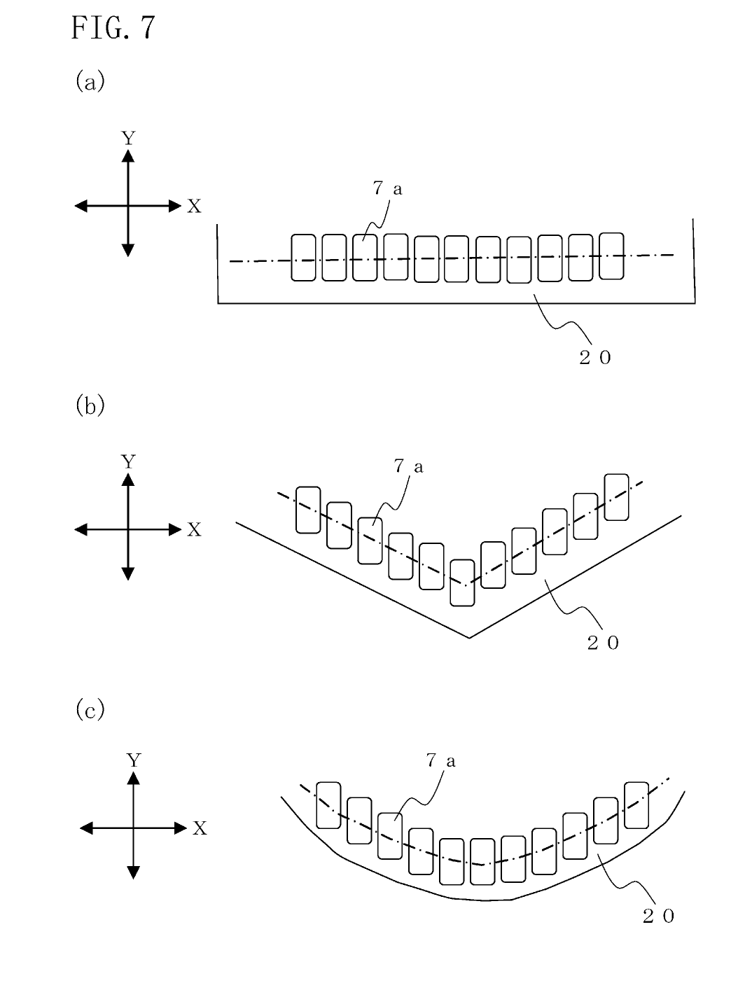

As in a conventional rectangular panel or a conventional irregularly-shaped panel, the display panel 20 is configured so that the connection terminals 7a of the connection terminal section 7 are arranged along an outer shape of the display panel 20 as illustrated in FIGS. 7(a) to 7(c). On the other hand, the connection terminal section 6 of the testing board 30 is arranged in the minor-inverted shape of the connection terminal section 7 of the display panel 20.

When the connection terminal section 7 of the display panel 20 and the connection terminal section 6 of the testing board 30 are stacked so as to face each other, each of the connection terminals 6a is arranged in a position facing the associated connection terminal 7a. The contact block 10 is interposed between the connection terminal sections 6 and 7, thereby electrically connecting each of the connection terminals 6a with the associated connection terminal 7a.

When a display test is performed for the display panel 20, an input signal such as a lighting signal is input from the testing board 30 to the display panel 20 after passing through the connection terminals 6a, the contact block 10, and the connection terminals 7a in this order. Conversely, an output signal from the display panel 20 is received by the testing board 30 after passing through the connection terminals 7a, the contact block 10, and the connection terminals 6a in this order.

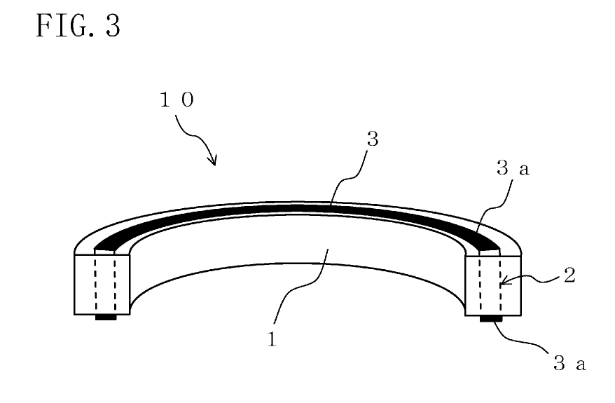

As illustrated in FIG. 3, the contact block 10 includes an alignment case 1 and a conductive block 3. Although a configuration of the contact block 10 will be described corresponding to the connection terminal section 7 and the connection terminals 7a of the display panel 20, the same correspondence relationship applies to the contact block 10 and the connection terminal section 6 and the connection terminals 6a of the testing board 30.

<Configuration of Alignment Case>

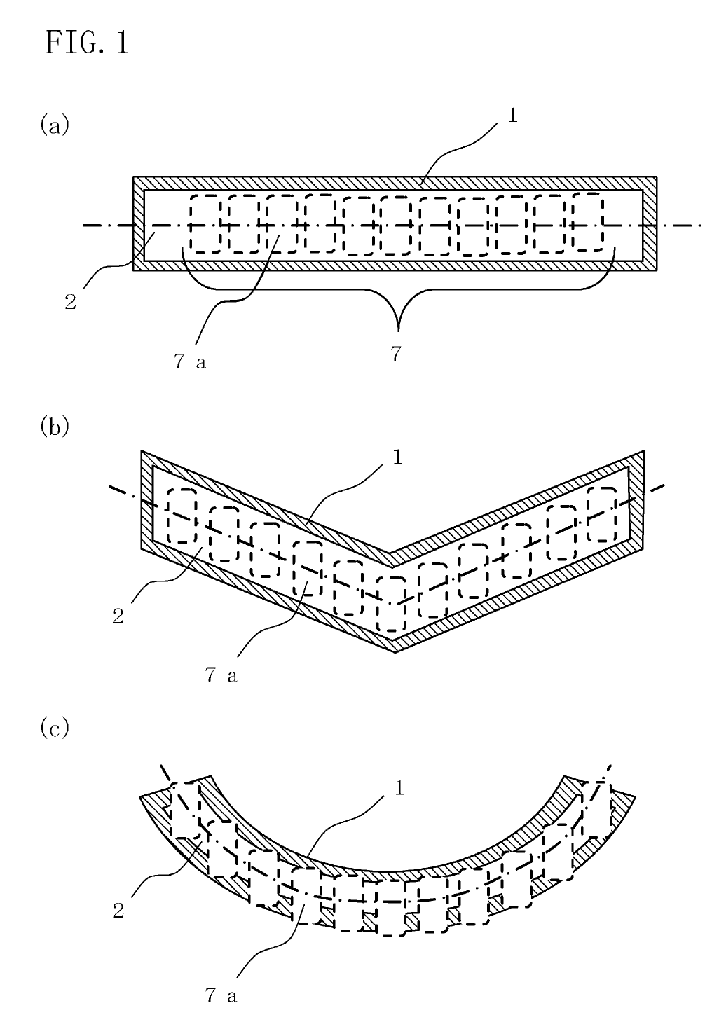

As illustrated in FIG. 1, a through-hole 2 in which the conductive block 3 is accommodated is provided in the alignment case 1. The through-hole 2 is for deforming the conductive block 3 which will be described later in accordance with the shape of the connection terminal section 7 of the display panel 20 and holding the conductive block 3. As illustrated in FIGS. 1(a) to 1(c), the through-hole 2 is formed in accordance with the shape of the connection terminal section 7.

The size of the through-hole 2 of the alignment case 1 is not limited. However, the through-hole 2 is formed so as to have the size which allows the entire connection terminals 7a to be exposed through the through-hole 2 when the through-hole 2 and the connection terminal section 7 overlap each other.

Note that, as illustrated in FIG. 1(c), an electric connection is allowed as long as at least part of each of the connection terminals 7a can be exposed through the through-hole 2.

Further, in the through-hole 2, it is desired that a center line of the through-hole 2 of the alignment case 1 is coincident with a center line connecting the centers of the plurality of connection terminals 6a as in, e.g., FIGS. 1(a) to 1(c).

If the size of the contact block 10 is increased more than necessary, the contact block 10 may contact components other than the connection terminal section 6 of the testing board 30 and the connection terminal section 7 of the display panel 20. Thus, there is a possibility that, e.g., the drive circuit 8 provided in the display panel 20 is damaged. However, the contact block 10 is designed so that the center line of the through-hole 2 of the alignment case 1 is coincident with the center line connecting the centers of the plurality of connection terminals 7a and the size and shape of the through-hole 2 are substantially the same as those of the connection terminal section 7, thereby ensuring an area required for connection in a connection surface 3a of the conductive block 3 which will be described later and forming the contact block 10 so as to have a compact shape. As a result, damage of components around the connection terminal section 7 due to contact of the contact block 10 can be prevented.

The material of the alignment case 1 may be a material, the shape of which is less likely to be changed. For example, inexpensive plastic or ceramic may be used.

The alignment case 1 may be formed by integral molding using the foregoing material or may be formed by opening the through-hole 2 in a block body. Alternatively, after a plate-shaped member is bended or two plate-shaped members are combined, end portions of the plate-shaped member(s) may be fixed with, e.g., fittings so as to face each other, thereby forming the through-hole 2.

<Configuration of Conductive Block>

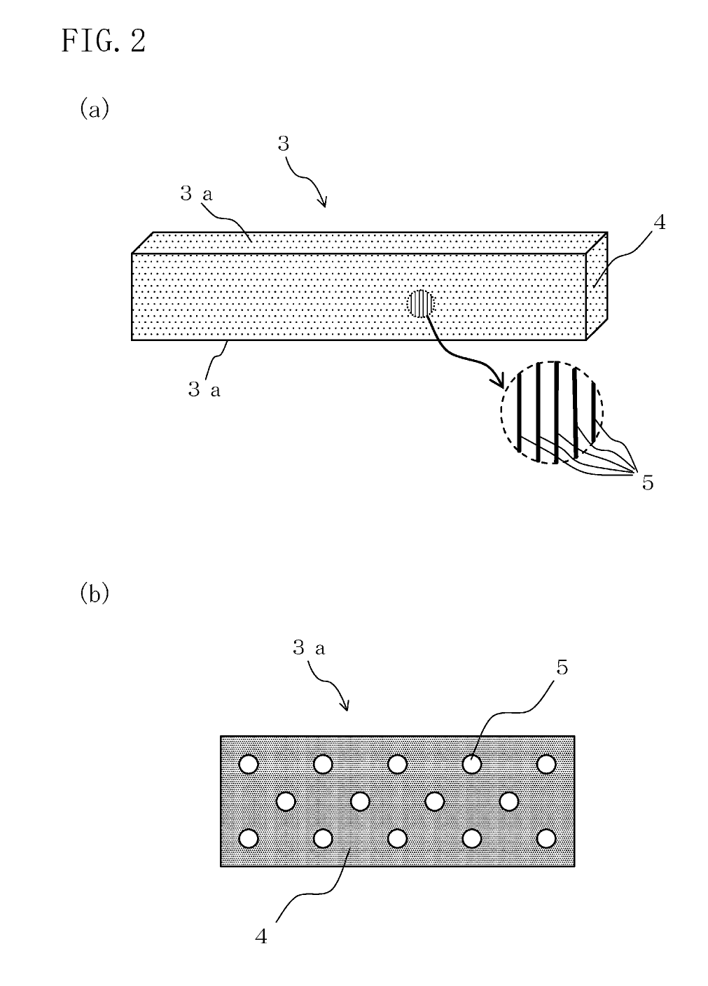

As illustrated in FIGS. 2(a) and 2(b), the conductive block 3 is a block having conductivity in a longitudinal direction and insulating properties in a lateral direction. Conductive wires 5 which are thin metal wires made of, e.g., gold having excellent conductivity are arranged parallel to the longitudinal direction inside an elastic rubber 4 having insulating properties, such as a silicon rubber.

The silicon rubber is described as the material of the elastic rubber 4. However, as long as the material of the elastic rubber 4 has insulating properties and elasticity, e.g., polyisoprene or urethane resin may be used. Similarly, the conductive wire 5 may be, other than the gold wires, thin metal wires made of, e.g., copper or aluminum having good conductivity, or plastic wires made of a conductive resin material.

Not a configuration in which a wire shape provides the conductivity in the longitudinal direction but a configuration in which conductive material particles are continuously arranged in the elastic rubber 4 to provide the conductivity in the longitudinal direction when the elastic rubber 4 is compressed may be employed.

The diameter of the conductive wire 5 is set to be smaller than the interval between adjacent ones of the connection terminals 7a. For example, if the interval between the connection terminals 7a is 30 μm, the conductive wire 5 having a diameter of 20 μm is used. The wire diameter is properly set as described above, thereby preventing a short caused due to a single wire crossing the connection terminals 7a.

The conductive wires 5 are arranged at substantially regular intervals in the elastic rubber 4. With a higher arrangement density, the contact block 10 becomes more adaptable to pitch reduction, and electric reliability can be enhanced. The conductive wires 5 are set to, e.g., 50 to 150 wires/mm² as the practical arrangement density.

At upper and lower ends of the conductive block 3 described above, the connection surfaces 3a to be electrically connected respectively to the connection terminals 6a and 7a are formed with end portions of the conductive wires 5 being exposed through the elastic rubber 4 as illustrated in FIG. 2(b).

The height of the conductive block 3 is set to be the same as that of the alignment case 1 or to be slightly greater than that of the alignment case 1, and the width and thickness of the conductive block 3 are set within a range in which the conductive block 3 can be accommodated in the through-hole 2.

Since the shape of the conductive block 3 is elastically deformed when the conductive block 3 is accommodated in the through-hole 2 of the alignment case 1, it is not necessary that the conductive block 3 is initially formed in accordance with the shape and size of the through-hole 2. The initial shape of the conductive block 3 is preferably a rectangular parallelepiped shape in order to fit any shapes of the alignment case 1.

<Configuration of Contact Block>

As illustrated in FIG. 3, the contact block 10 is configured so that, in the alignment case 1, the conductive block 3 press-contacts the through-hole 2 and is fixed by friction force. In addition, it may be ensured that the conductive block 3 is further fixed by using, e.g., an adhesive.

If the width of the conductive block 3 is smaller than that of the through-hole 2, the conductive block 3 may be fixed so that clearances are formed by the conductive block 3 in end portions of the through-hole 2. One type of alignment case 1 can be combined with each of conductive blocks 3 having various widths.

The conductive block 3 is elastically deformed when the conductive block 3 is inserted into the through-hole 2. Since the through-hole 2 is formed in accordance with the shape of the connection terminal section 7, each of the connection surfaces 3a of the conductive block 3 exposed through the through-hole 2 is in a planar shape in accordance with the connection terminal section 7. Thus, the connection surfaces 3a to be electrically connected respectively to the connection terminals 7a of the display panel 20 and the connection terminals 6a of the testing board 30 are formed at upper and lower ends of the contact block 10.

The connection surfaces 3a at the upper and lower ends of the contact block 10 are in the planar shape in accordance with the connection terminal sections 6 and 7. Thus, since the connection surfaces 3a respectively overlap all of the plurality of connection terminals 7a of the display panel 20 and all of the plurality of connection terminals 6a of the testing board 30, the plurality of connection terminals 6a and 7a can be simultaneously connected together. Unlike conventional probe needles each connecting connection terminals together at a single point, the contact block 10 connects the connection terminals 6a and 7a together over the entirety of the surfaces of the contact block 10, thereby improving contactability between the connection terminals 6a and 7a.

The contact block 10 is configured so that the alignment case 1 and the conductive block 3 can be detached from each other even after assembly of the alignment case 1 and the conductive block 3. Another contact block 10 can be configured by, e.g., combining the detached conductive block 3 with another alignment case 1.

For example, a plural types of alignment cases 1 are prepared corresponding to the shape of the irregularly-shaped panel or the size of the connection terminal sections 6 and 7, and a plural types of conductive blocks 3 having different arrangements or densities of the conductive wires 5 considering the pitch of the connection terminals 6a or 7a are prepared. The alignment cases 1 are respectively combined with the conductive blocks 3 as necessary, thereby forming the contact blocks 10 corresponding to a wide range of panels such as rectangular panels and various irregularly-shaped panels. Consequently, an expensive probe unit is not necessarily prepared for each type of irregularly-shaped panels, resulting in cost saving.

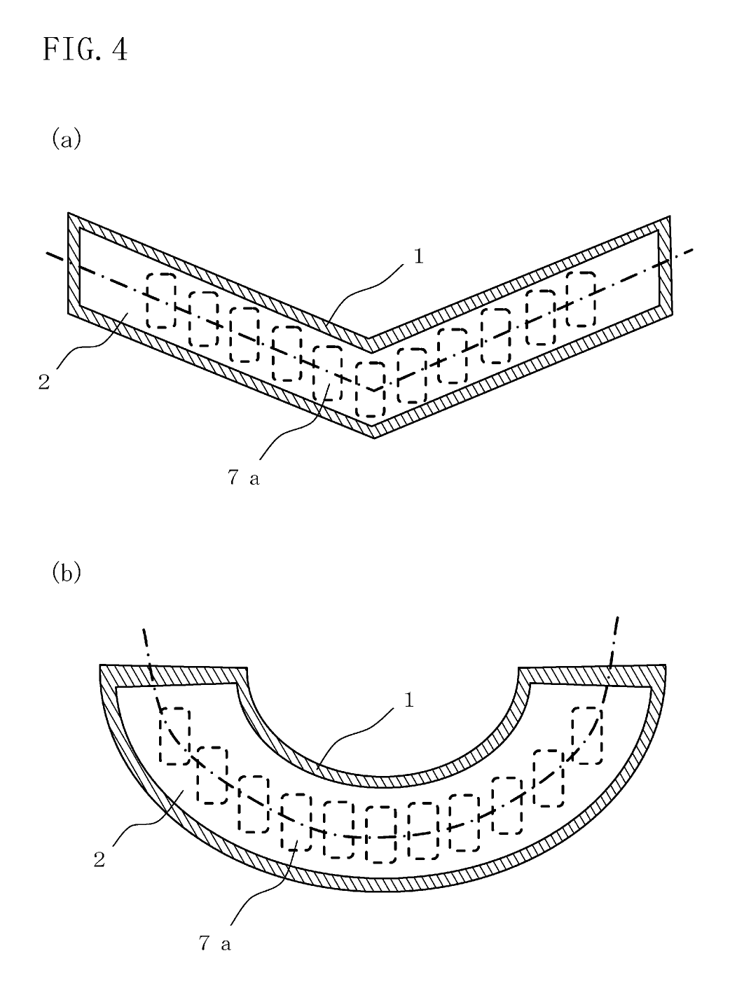

In order to handle, e.g., a case where the connection terminal section 7 is changed into a larger one due to an increase in number of the terminals of the connection terminal section 7, the size of the through-hole 2 of the alignment case 1 may be set so that there is room in the longitudinal direction as illustrated in FIG. 4(a). Alternatively, slight room may be provided so as to surround the connection terminal section 6 or 7 as illustrated in FIG. 4(b). Thus, even if some changes are made in the size or arrangement of the connection terminal section 7, the contact block 10 can be used, thereby enhancing versatility of the contact block 10.

As described above, the size of the through-hole 2 is larger than that of each of the connection terminal sections 6 and 7, and the size of the conductive block 3 is larger than that of each of the connection terminal sections 6 and 7. This allows a testing device to easily adjust positions of the connection surface 3a of the contact block 10 and the connection terminal section 7, thereby improving the electric reliability when the connection surface 3a and the connection terminal section 7 are connected together.

<Description of Operation of Contact Block>

Arrangement of the contact block 10 in the testing device is as illustrated in FIG. 5. After the display panel 20 which is a board to be tested is mounted, the position of the contact block 10 is adjusted to the position of the connection terminal section 7 of the display panel 20. Subsequently, the position of the connection terminal section 6 of the testing board 30 is adjusted to the position of the contact block 10. Note that the contact block 10 and the testing board 30 may be arranged in the testing device in a state in which the positions of the contact block 10 and the testing board 30 are adjusted to each other in advance.

The contact block 10 is pressed in a state in which the contact block 10 is sandwiched between the connection terminal section 6 of the testing board 30 and the connection terminal section 7 of the display panel 20, and the connection surfaces 3a at the upper and lower ends of the contact block 10 contact the connection terminals 6a and 7a, respectively. In such a manner, the display panel 20 and the testing board 30 are electrically connected together through the conductive wires 5 provided inside the conductive block 3.

Note that the conductive block 3 may be set so as to have the same height as that of the alignment case 1, and therefore the connection surfaces 3a may be positioned at the same surface levels as upper and lower surface levels of the alignment case 1, respectively. By forming the conductive block 3 so as to be larger than the alignment case 1 and protrude beyond the alignment case 1, damage can be prevented without contact between the alignment case 1 and the display panel 20 or the testing board 30 even if the conductive block 3 is pressed and contracted between the connection terminals 6a and 7a by contacting the connection terminals 6a and 7a.

Every time the conductive block 3 contacts the connection terminals 6a and 7a, the conductive block 3 is contracted and returned to the initial shape. Since the conductive wires 5 are held in a state in which the entire conductive wires 5 are embedded in the elastic rubber 4, adjacent ones of the conductive wires 5 do not contact each other due to displacement thereof. Thus, the insulating properties of the conductive block 3 in the lateral direction (direction crossing the connection terminals) can be ensured.

Note that, if recesses and protrusions are formed in the connection surface 3a due to repeated use, the connection surface 3a (the elastic rubber 4 and the conductive wires 5) is polished and flattened, thereby improving the contactability. In addition, since the conductive block 3 is elastically deformed and returned to the initial shape when the conductive block 3 is detached from the alignment case 1, the conductive block 3 can reused, i.e., can be inserted into another alignment case 1 having a different shape.

### Second Embodiment

When a contact block 10 is used to examine electronic properties of an electronic circuit device which is a device to be examined, there are conductive wires 5 which do not contact connection terminals 6a and 7a in a conductive block 3. The conductive wires 5 which do not contact the connection terminals 6a and 7a have unstable potential. Thus, such conductive wires 5 may function as antennas to receive electromagnetic waves from outside, and then such electromagnetic waves may be propagated to the conductive wires 5 connected to the connection terminals 6a and 7a. As a result, noise may be superimposed on a test signal.

On the other hand, in a second embodiment of the present invention, the alignment case 1 of the first embodiment functions as an electromagnetic shield. At least part of the alignment case 1 is made of a conductive material e.g., by plating an outer circumferential surface of the alignment case 1 or a wall surface of a through-hole 2 with metal or by bonding a metal mesh such as an expanded metal.

When the electromagnetic waves enter the conductive material, eddy current is caused. Since magnetic lines of force caused by the eddy current function to cancel out magnetic lines of force of the electromagnetic waves, the electromagnetic waves cannot pass through the conductive material. Thus, since part of the alignment case 1 is made of the conductive material, the electromagnetic waves do not reach the conductive wires 5. As a result, superimposition of noise on a test signal can be prevented.

Further, the conductive material is connected to ground (GND) of the testing device, and therefore the alignment case 1 is not charged even if the eddy current flows therethrough. Thus, noise due to electrostatic discharge can be prevented.

### INDUSTRIAL APPLICABILITY

The contact block of the present invention can be broadly applied to general semiconductor devices other than display panels such as liquid crystal displays, organic EL displays, and plasma displays. Although the present invention has been described as part of the testing device, the present invention is not limited to the foregoing and may be used for purpose of connecting connection terminals together.

### DESCRIPTION OF REFERENCE CHARACTERS

1 Alignment Case
2 Through-Hole
3 Conductive Block
3a Connection Surface
4

Elastic Rubber
5 Conductive Wire
6, 7 Connection Terminal Section
6a, 7a Connection Terminal
8 Drive Circuit
9 Display Section
10 Contact Block
20 Display Panel
30 Testing Board

1. A contact block for electrically connecting connection terminals together, comprising:
a conductive block including an elastic body and a conductive member held inside the elastic body; and
an alignment case including a through-hole into which the conductive block is inserted,
wherein the through-hole is formed in a shape corresponding to arrangement of the connection terminals.

2. The contact block of claim 1, wherein
the conductive block protrudes beyond the alignment case.

3. The contact block of claim 1, wherein
at least part of the alignment case is made of a conductive material.
